(19) United States
(12) Patent Application Publication
(10) Pub. No.: US 2026/0357851 A1
(43) Pub. Date: Nov. 12, 2026

(54) Bearing Adjustment Device, Calender and Method for Producing a Web-Like Product

(71) Applicants: Matthews International Corporation, Pittsburgh, PA (US); Matthews International GmbH, Vreden (DE)

(72) Inventors: Henning WAMELING, Oeding (DE); Timo GRÜHSINGER, Steinfurt (DE); Harald BARTSCH, Dorsten (DE)

(21) Appl. No.: 19/128,629

(22) PCT Filed: Nov. 25, 2022
(86) PCT No.: PCT/DE2022/100884

§ 371 Date: May 9, 2025

(51) Int. Cl. F16C 23/10; B29C 43/24; B29C 43/46; B29L 7/00; B29L 31/34; F16C 13/02; H01M 4/04

(52) U.S. Cl. CPC F16C 23/10; B29C 43/245; B29C 43/46; F16C 13/02; H01M 4/0435; B29C 2043/467; B29L 2007/008; B29L 2031/3406

(57) ABSTRACT

The invention relates to a bearing adjustment device (1), which has a rotatably mounted outer eccentric sleeve (2) and a rotatable inner eccentric sleeve (3) which is received in the outer eccentric sleeve (2), wherein the inner eccentric sleeve (3) has a receptacle (4), wherein the outer eccentric sleeve (2) and the inner eccentric sleeve (3) can be rotated relative to one another, preferably in opposite directions, and are configured such that in the event of a relative rotation, preferably an opposite rotation, of the outer eccentric sleeve (2) with respect to the inner eccentric sleeve (3), a centre axis (A) of the receptacle (4) is adjusted in an adjustment direction (V), preferably in a vertical direction. The invention also relates to a calender and to a method for producing a web-like product.

The invention relates to a bearing adjustment device, a calender with a bearing adjustment device and a method for producing a web-like product, for example an electrode film.

Bearing adjustment devices according to the invention can be used, for example, in the production of films, e.g. plastic films. A plastic material can be placed into a roller nip to produce a plastic film. The width of the roller nip, which can have an impact on the film thickness and the manufacturing process, and thus on the film quality, can be adjusted by a bearing adjustment device according to the invention. The film can be produced using a calender, which can have two rollers with a corresponding roller nip.

However, the bearing adjustment device according to the invention and/or calender according to the invention with corresponding bearing adjustment devices are not limited thereto, but can also be used or provided for the production of other products, in particular other web-like products or web-like materials.

For example, a calender according to the invention or a bearing adjustment device according to the invention can also enable or allow the coating of a web-like carrier with a coating material. For example, a coating agent can be applied to a web-like carrier guided through a roller nip by a coating roller, wherein the width of the roller nip can be adjusted by the bearing adjustment device. This means, for example, that the roller nip can be adjusted depending on the coating process, the coating material and/or the web-like carrier. Likewise, a roller nip can be adjusted by a bearing adjustment device according to the invention during powder milling and/or during production of a polymer-metal dry film.

The bearing device can also be used to adjust engraving rollers or embossing rollers. Engraving devices or embossing devices can have a bearing device according to the invention.

Calenders are used, for example, in film production, especially in the production of electrode films; The electrode film can then be used to produce an electrode for an electrical energy storage device such as a battery.

During the production of an electrode film, a powdered electrode precursor material is introduced into a nip of a roller pair of a calender and compressed before being further processed into a dry electrode. A manufacturing method of a dry electrode is known, for example, from WO 2020/148410 A2.

The electrochemical properties of correspondingly produced electrode films or electrodes, such as the capacity and efficiency of battery electrodes are determined by various factors, such as the distribution of the active material, the binder, and the additives, the physical properties of the materials contained therein, such as particle size and surface area of the active material, the surface properties of the active materials and the physical properties of the electrode film, such as density, porosity, cohesion, and adhesion to a conductive element. Dry processing systems and methods traditionally use a processing step with high shear and/or high pressure to break up and mix the electrode film materials. Such systems and methods can contribute to structural advantages over wet-produced electrode films. However, due to the high processing pressures, the rollers can be deflected during calendering, which can change the width of the roller nip, with negative effects on the quality of the produced electrode film. An adjustment of the nip width is therefore desirable. To counteract the deflection of the rollers, an axis crossing of the rollers can be carried out, in which one or both of the rollers are pivoted about an axis of rotation perpendicular to their longitudinal axis. A corresponding calender is known, for example, from EP 3 792 394 A1, in which the roller or a bearing of the roller is pivoted in a circular arc via a rocker. This also results in an adjustment of the roller in a direction perpendicular to the main adjustment direction.

It is therefore an object of the present invention to provide a bearing adjustment device, a calender and a method of producing an electrode film in which a flexible and precisely adjustable adjustment of the roller and flexible and precise adjustment of the nip width are realized, so that an electrode film of high quality can be produced. In preferred embodiments of the invention, a linear adjustment takes place only in one adjustment direction.

The object of the invention is achieved by a bearing adjustment device according to claim 1, a calender according to claim 14 and a production method according to claim 21. Preferred embodiments are the subject matter of the respective dependent claims.

A first aspect of the invention relates to a bearing adjustment device which has a rotatably mounted outer eccentric sleeve and a rotatable inner eccentric sleeve which is received in the outer eccentric sleeve, wherein the inner eccentric sleeve has a receptacle, wherein the outer eccentric sleeve and the inner eccentric sleeve are rotatable relative to one another and are designed such that in the event of a relative rotation of the outer eccentric sleeve with respect to the inner eccentric sleeve, the center point of the receptacle is adjusted in an adjustment direction. In some embodiments, the outer eccentric sleeve and the inner eccentric sleeve can be rotated relative to one another and can be configured such that when the outer eccentric sleeve is rotated in the opposite direction to the inner eccentric sleeve, the center point of the receptacle is adjusted in an adjustment direction. The adjustment direction can be a vertical direction. The bearing adjustment device thus allows simple and flexible adjustment of the receptacle and thus of a roller or roll supported by the bearing adjustment device.

The outer eccentric sleeve and/or the inner eccentric sleeve can be substantially hollow cylindrical. A wall thickness of the outer eccentric sleeve and/or the inner eccentric sleeve can vary in the circumferential direction. The receptacle can be cylindrical and/or round. The center axis of the receptacle can be an axis of symmetry of the receptacle. The center axis of the receptacle can be aligned perpendicular to the adjustment direction. The center axis can run in the direction of extension of the receptacle. The center axis can be located centrally in the receptacle.

The center axis of the receptacle can be adjusted by a maximum distance of up to 20 mm in the adjustment direction. It may be provided that the center point of the receptacle can be adjusted by a maximum distance in the adjustment direction of up to 15 mm. In some embodiments, the center point of the receptacle may be adjustable by a maximum distance in the adjustment direction of 12 mm. In some embodiments, however, the maximum distance may also be greater or smaller, e.g. depending on a manufacturing process and/or a web-like material to be produced. The maximum distance can be the maximum possible distance of the position of the center axis. The maximum distance can be measured between a “low point” of the center axis and a “high point” of the center axis. The distance in the adjustment direction can be zero at the “low point”. The low point can define a reference position of the center axis. If the distance is measured relative to the reference position, the distance at the “low point” may be zero. In some embodiments, the outer eccentric sleeve and the inner eccentric sleeve may be rotated such that the center axis is at the “low point” so that the distance may be zero. Upon further rotation of the outer eccentric sleeve and/or the inner eccentric sleeve, in some embodiments by counter-rotating, the distance may increase due to the rotation until the maximum distance is reached, namely the center axis is, for example, at the “highest point”. If rotation is continued, the distance may decrease again. In some embodiments, the maximum distance may depend on the dimensioning of the bearing adjustment device, the inner eccentric sleeve and/or the outer eccentric sleeve.

The outer eccentric sleeve and the inner eccentric sleeve can be designed so that when the outer eccentric sleeve is rotated in the opposite direction to the inner eccentric sleeve, the center point of the receptacle is not adjusted in a direction perpendicular to the adjustment direction. In some embodiments, the outer eccentric sleeve and the inner eccentric sleeve can be configured so that when rotated in opposite directions, the center point of the receptacle is not adjusted in a horizontal direction.

The inner eccentric sleeve may have a first eccentric gear. The first eccentric gear can be or have a non-circular gear. The outer eccentric sleeve may have a second eccentric gear. The second eccentric gear can be or have a non-circular gear. If the first eccentric gear and/or the second eccentric gear is non-circular, an eccentricity of the inner bearing sleeve and/or the outer bearing sleeve can be compensated for in such a way that the respective eccentric gear can be driven easily and simply with a simple or round gear, for example a spur gear.

The first eccentric gear may be arranged on a first side of the bearing adjustment device, and the second eccentric gear may be arranged on a second side of the bearing adjustment device. The second side may be arranged opposite the first side. This allows the respective eccentric gears to be easily accessible, for example, to be driven by other gears. It can be provided that, with a corresponding arrangement of the eccentric gears, torques caused by their weight can also be at least partially compensated. In some embodiments, a center of gravity of the bearing adjustment device can also be moved closer to and/or coincide with a geometric center of the bearing adjustment device, so that the holding of the bearing adjustment device can be or become better, for example after assembly.

The bearing adjustment device may comprise a drive which may be configured to drive and/or rotate the inner eccentric sleeve and/or the outer eccentric sleeve. In some embodiments, the drive may drive the inner eccentric sleeve and the outer eccentric sleeve independently and/or individually. In some embodiments, the outer eccentric sleeve and the inner eccentric sleeve may be or become independently rotated. In some other embodiments, the drive may drive the inner eccentric sleeve and the outer eccentric sleeve such that when the inner eccentric sleeve is rotated, the outer eccentric sleeve is also rotated, and/or vice versa.

The drive may comprise a manual adjustment, an electric motor, a stepper motor, an encoder drive and/or a hydraulic motor.

The drive may include a first gear coupled to the first eccentric gear, a second gear coupled to the first gear, and a third gear coupled to the second eccentric gear. The first gear may be or comprise a first spur gear. The second gear may be or comprise a second spur gear. The third gear may be or comprise a third spur gear.

The drive may include a shaft that can couple the second gear to the third gear. In some embodiments, the shaft may extend substantially parallel to the inner eccentric sleeve and the outer eccentric sleeve. The drive may be configured to drive and/or rotate the shaft and/or apply a torque to the shaft.

The gear ratio of the first gear to the first eccentric gear, of the second gear to the first gear and of the third gear to the second eccentric gear can each be selected such that when the shaft rotates, the inner eccentric sleeve can be rotated in the opposite direction by the same angle relative to the outer eccentric sleeve.

At least one of the gears may be a split gear and/or have at least two gear halves coupled to each other. It can be provided that one, several or all of the first eccentric gear, second eccentric gear, first gear, second gear and/or third gear can be a split gear and/or can have at least two gear halves coupled to one another. The gear balves can be coupled and/or clamped together, for example, via a spring, such as a torsion spring or an omega spring. Alternatively or additionally, the gear halves can be coupled and/or clamped together using an elastic material. The elastic material can be arranged between the gear halves. The elastic material can, for example, be or comprise an elastomer.

If a gear is split, the division can result in improved contact and/or meshing of the teeth of the split gear with the teeth of another gear, or in better meshing. The gear play can be reduced or even brought to zero.

The bearing adjustment device may comprise a second drive which may be configured to drive the inner eccentric sleeve and/or the outer eccentric sleeve. The second drive may have one, several, or all of the features and/or advantages of the drive. The second drive may comprise a manual adjustment, an electric motor, a stepper motor, an encoder drive and/or a hydraulic motor,

By pre-tensioning both drives against each other, the position of the eccentric sleeves can be kept free of play. For example, one of the drives can block and the other can build up a defined preload with any torque to eliminate backlash. In some embodiments the second drive may be configured to drive and/or rotate the shaft and/or apply a torque to the shaft. It can be provided that the drive and the second drive can rotate the shaft in the same and/or opposite direction of rotation, and/or can each apply torques on the shaft in the same or opposite direction, and/or with the same or different strength.

The outer eccentric sleeve, the inner eccentric sleeve and the receptacle can be aligned parallel to each other. It can be provided that the axes of rotation of the outer eccentric sleeve and the inner eccentric sleeve can be aligned parallel to each other and/or spaced parallel from each other. In some embodiments, axes of symmetry of the outer eccentric sleeve, the inner eccentric sleeve and the receptacle may be aligned parallel to each other and/or spaced parallel from each other.

The inner eccentric sleeve can protrude beyond the outer eccentric sleeve.

The first eccentric gear can be arranged such that it can axially secure the inner eccentric sleeve relative to the outer eccentric sleeve. The inner eccentric sleeve may have a first retaining ring that can axially secure the inner eccentric sleeve relative to the outer eccentric sleeve. The first retaining ring may be arranged opposite the first eccentric gear.

The outer eccentric sleeve can be rotatably mounted in a housing, wherein the second eccentric gear can axially secure the outer eccentric sleeve relative to the housing. The outer eccentric sleeve may have a second retaining ring which can axially secure the outer eccentric sleeve relative to the housing. The second retaining ring may be arranged opposite the second eccentric gear.

The bearing adjustment device may comprise a bearing which may be arranged in the receptacle. The bearing can be or have a rolling bearing. For example, a roller or roll can be incorporated into the rolling bearing. If a bearing is incorporated into the receptacle, the center axis of the receptacle can correspond to or coincide with a center axis of the bearing. If a roller or roll is mounted in the bearing, the center axis of the receptacle may correspond to or coincide with a rotational axis of the roller or roll.

However, the bearing adjustment device according to the invention is not limited to calenders and/or calendering processes. Other uses are also conceivable.

A further aspect of the present invention relates to a calender comprising a bearing adjustment device as described above and a roller pair with a nip between the rollers of the roller pair, one of the rollers being supported by the bearing adjustment device. This means that one or both rollers of the roller pair can be pivoted against each other and/or crossed axially by adjusting the center axis of the receptacle. In some embodiments, alternatively or additionally, the roller nip can be or become flexible and easily adjusted.

Each of the rollers of the roller pair can be supported at its lateral ends by a bearing adjustment device as described above. This allows the rollers to be pivoted towards each other or crossed axially even more flexibly. Alternatively or additionally, the roller nip can be set to be even more flexible.

The calender may have a powder hopper for filling powder into the roller nip. This can result in a good and uniform filling of the roller nip. The powder may be or comprise a powdered electrode film precursor material.

The calender may have a support roller, wherein the support roller may laterally support one of the rollers of the roller pair. This means that transverse forces from the roller can be absorbed laterally by the support roller.

The support roller can be supported by another bearing adjustment device as described above. This means that the support roller can be or has been adjusted. This ensures that even an adjusted roller can be laterally supported by the adjusted support roller.

One of the rollers of the roller pair can be pivoted and/or axially crossed relative to the other roller of the roller pair by adjusting the center axis of the receptacle of the bearing adjustment device in the adjustment direction. The adjustment and/or axial crossing, and/or the nip width of the roller nip, can be varied during operation. In some embodiments, the calender may include a sensor that can detect the adjustment and/or axial crossing, and/or the nip width of the roller nip. The adjustment can be made during operation, for example based on the data detected by the sensor.

Yet another aspect of the invention relates to a method for producing a web-like product using a calender, the method comprising the steps of:
feeding a precursor material into a roller nip of a roller pair of the calender;
producing the web-like product, wherein at least one of the rollers of the roller pair contacts the precursor material in the roller mip;
wherein during compression, at least one of the rollers of the roller pair is pivoted and/or axially crossed relative to the other roller, wherein the adjustment and/or axial crossing of the roller comprises an adjustment of a center axis of a bearing adjustment device supporting the roller and described above in an adjustment direction. This means that a web-like product of high and/or consistent quality can be or will be produced.

The calender may be or comprise a calender as described above.

The precursor material may comprise a plastic and the web-like product may be a plastic film, wherein during the production of the web-like product the precursor material may be formed into the plastic film by the rollers.

The precursor material may comprise a web-like carrier and one of the rollers may be or comprise a coating roller, wherein, during the manufacture of the web-like product, a coating agent may be applied to the web-like carrier by the coating roller.

The precursor material may comprise a powdered electrode film precursor material, wherein feeding the precursor material may comprise introducing the powdered electrode film precursor material into the roller nip; and wherein producing the web-like product may comprise compressing the powdered electrode film precursor material with the rollers of the roller pair of the calender.

Before introducing the powdered electrode film precursor material into the roller nip, the powdered electrode film precursor material may be filled into a powder hopper of the calender, and the powdered electrode film precursor material may be introduced into the roller nip with the powder hopper.

The compressed electrode film precursor material can be compressed into a film during compression. After compressing the electrode film precursor material, the compressed electrode film precursor material can be further pressed. The compressed electrode film precursor material can be further pressed with another roller pair.

The further pressed electrode film precursor material can be pressed into a film during further pressing. After further pressing, an electrode film may be formed, wherein forming the electrode film may comprise laminating the further pressed electrode film precursor material.

In some embodiments, it may alternatively be provided that an electrode film may be formed after compressing the electrode film precursor material, wherein forming the electrode film may comprise laminating the compressed electrode film precursor material.

In forming the electrode film, a first compressed electrode film precursor material and/or a first further compressed electrode film precursor material may be laminated onto a first side of the metal foil, and a second compressed electrode film precursor material and/or a second further compressed electrode film precursor material may be laminated onto a second side of the metal foil opposite the first side.

In some embodiments, one, several, or all of the steps of the described methods may be performed in a different order.

The invention is further explained with reference to the following figures. In the figures:

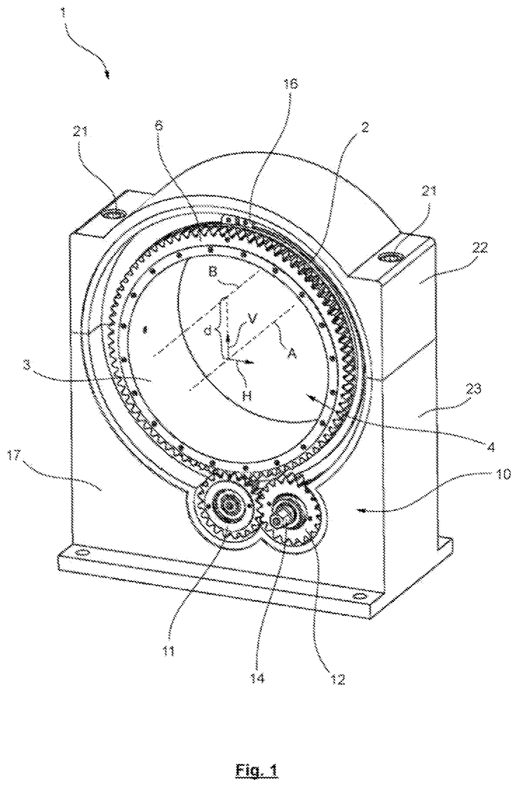

FIG. 1 shows a perspective view of an exemplary embodiment of a bearing adjustment device according to the invention;

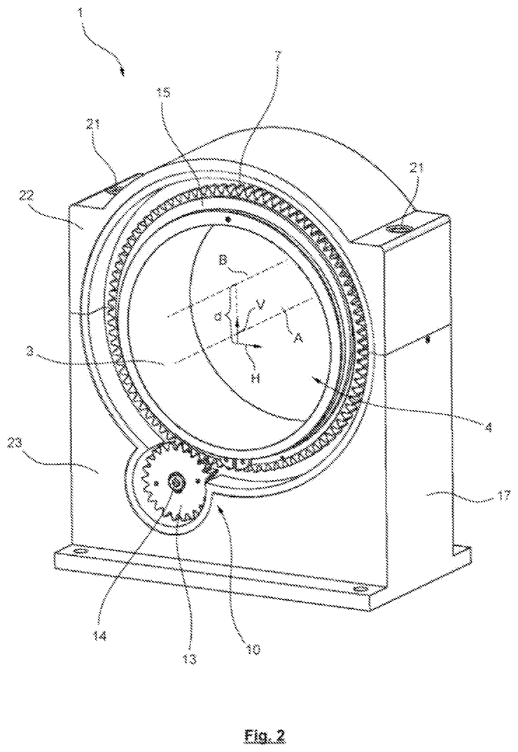

FIG. 2 shows a further perspective view of the exemplary embodiment shown in FIG. 1;

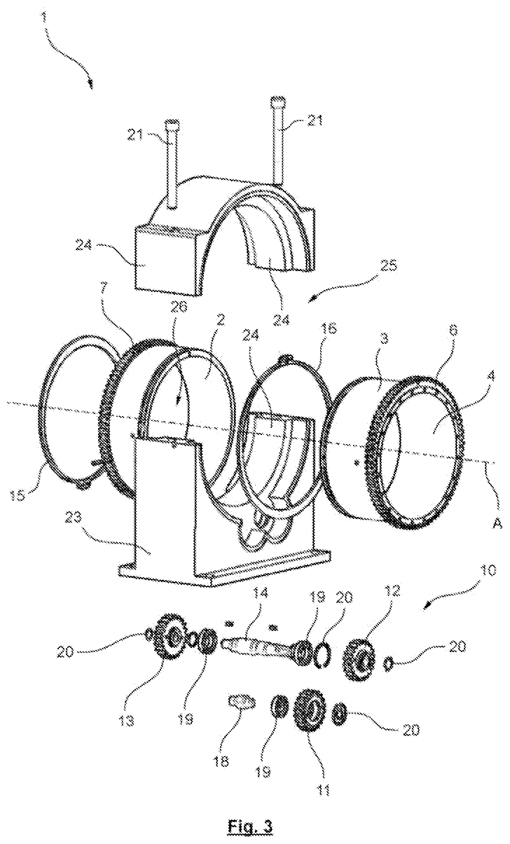

FIG. 3 shows an exploded view of the exemplary embodiment shown in FIGS. 1 and 2;

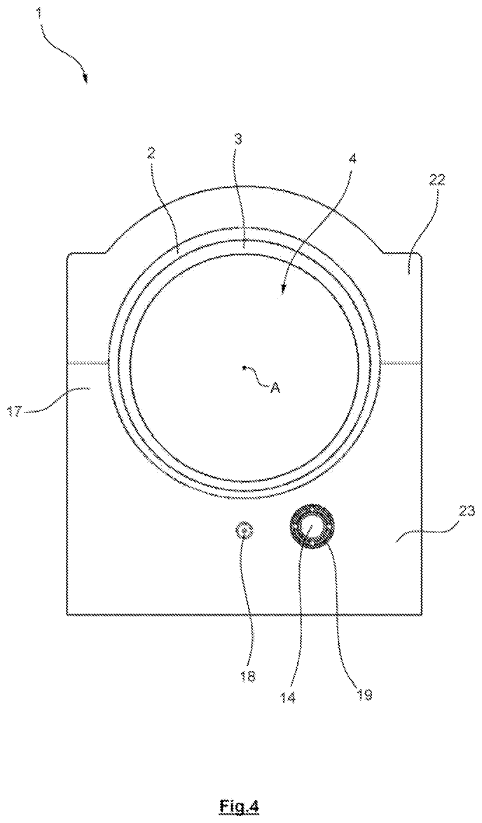

FIG. 4 shows a sectional view of the exemplary embodiment shown in FIGS. 1 to 3; and

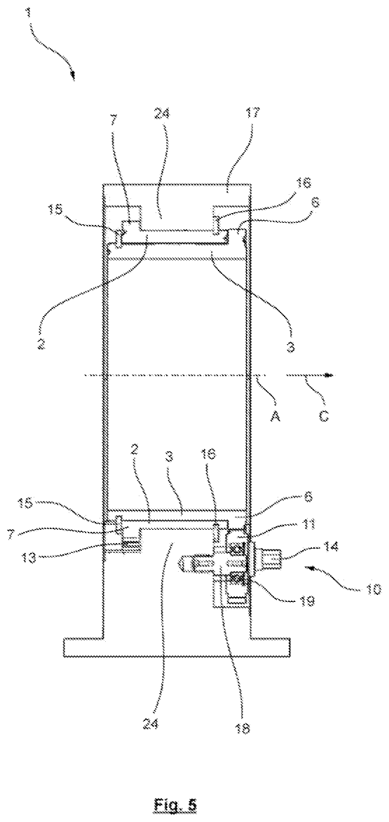

FIG. 5 shows a further sectional view of the exemplary embodiment shown in FIGS. 1 to 4; and

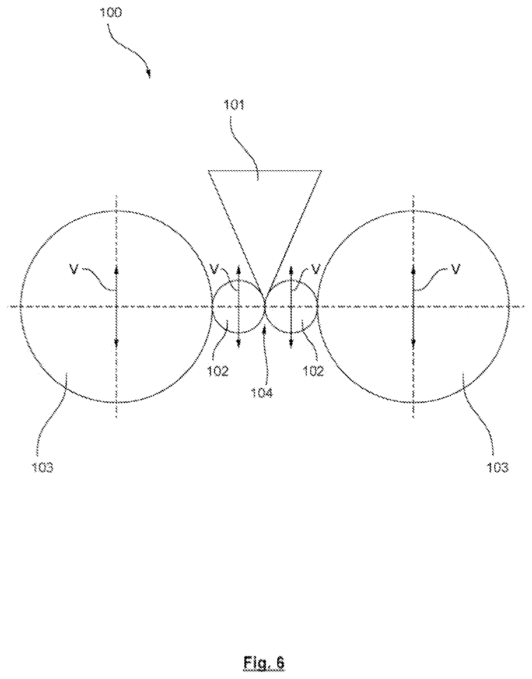

FIG. 6 shows a schematic view of an exemplary embodiment of a calender according to the invention.

FIGS. 1 to 5 show an exemplary embodiment of a bearing adjustment device 1 according to the invention. FIG. 1 shows one side of the bearing adjustment device 1 and FIG. 2 shows an opposite side. FIG. 3 shows an exploded view of the bearing adjustment device 1. FIG. 4 shows a cross-sectional view and FIG. 5 shows a longitudinal sectional view of the bearing adjustment device 1.

The bearing adjustment device 1 has an outer eccentric sleeve 2 and an inner eccentric sleeve 3. The outer eccentric sleeve 2 is rotatably mounted in the bearing adjustment device 1 and/or a housing 17 of the bearing adjustment device 1, for example by means of an eccentric sleeve bearing 24. The inner eccentric sleeve 3 is received in the outer eccentric sleeve 2 and rotatably mounted in the outer eccentric sleeve 2. The outer eccentric sleeve 2 and the inner eccentric sleeve 3 can be rotated in opposite directions. The outer eccentric sleeve 2 and/or the inner eccentric sleeve 3 can be substantially hollow-cylindrical and/or have a substantially hollow-cylindrical shape. The outer eccentric sleeve 2 and/or inner eccentric sleeve 3 can be rotatable about a respective axis of rotation, which can be aligned parallel to an axial direction C of the bearing arrangement. The wall thickness of the outer eccentric sleeve and/or the inner eccentric sleeve can vary in the circumferential direction.

The inner eccentric sleeve 3 has a receptacle 4. A bearing (not shown in the figures), for example a rolling bearing, can be accommodated in receptacle 4. The bearing can be mounted in the receptacle 4 and/or attached to or in it. The bearing can be or have, for example, a roller bearing or a ball bearing. The bearing can be used to support a roll and/or a roller. The receptacle 4 has a center axis A. The center axis A can be an axis of symmetry of the receptacle 4. The center axis can run in the direction of extension of the receptacle 4. The center axis A can be located centrally in the receptacle 4.

The outer eccentric sleeve 2 can be accommodated in an outer eccentric sleeve receptacle 25 of the bearing adjustment device 1 (see, for example, FIG. 3). The inner eccentric sleeve 3 can be received in an inner eccentric sleeve receptacle 25 of the outer eccentric sleeve 2. Outer eccentric sleeve receptacle 25, inner eccentric sleeve receptacle 26 and/or receptacle 4 can be circular and/or cylindrical. A respective center point and/or respective center axes of the outer eccentric sleeve receptacle 25, inner eccentric sleeve receptacle 26 and/or receptacle 4 can be arranged eccentrically and/or non-coincidentally.

When the outer eccentric sleeve 2 and/or the inner eccentric sleeve 3 rotates, the center axis A of the receptacle 4 of the inner eccentric sleeve 3 can be or become adjusted in an adjustment direction V due to the eccentricity of the outer eccentric sleeve 2 or the inner eccentric sleeve 3.

Preferably, the outer eccentric sleeve 2 and the inner eccentric sleeve 3 can be rotated in opposite directions such that the center axis A or points on the center axis 4 are adjusted only in the adjustment direction V. In other words, it can be provided that by the opposite rotation of the outer eccentric sleeve 2 and the inner eccentric sleeve 3, an adjustment of the center axis A in a direction H perpendicular to the adjustment device is compensated, so that the center axis A or points on the center axis A are not or will not be adjusted in the direction H. For example, the outer eccentric sleeve 2 and the inner eccentric sleeve 3 can be designed in such a way that, upon opposite rotation by an equal respective angle value of rotation, the center axis is or will be adjusted only in the adjustment direction V. It can be provided that the center axis A moves linearly in the adjustment direction V and/or is or will be moved or adjusted. This can, for example, enable precise adjustment of a roller nip.

For the exemplary embodiment shown as an example, the center axis A of the receptacle 4 can be arranged at a “low point” along the adjustment direction V in the orientations of the outer sleeve 2 and inner sleeve 3 shown in FIGS. 1 and 2. When rotated in the opposite direction by 180°, the center axis A can have a maximum distance d relative to this low point in the adjustment direction V, namely the center axis B adjusted in this way can be spaced parallel to the center axis passing through the “low point” by the maximum distance d in the adjustment direction V. With an opposite rotation up to an angle (amount) of 180°, the distance d can increase up to the maximum distance. When rotating in the opposite direction beyond 180°, the distance d can decrease again until it can be zero when rotating through an angle (amount) of 360°. The maximum distance d and thus the maximum adjustment of the center axis A in the adjustment direction V can be a maximum of 20 mm in some embodiments. The maximum distance d and thus the maximum adjustment of the center axis A in the adjustment direction V can be a maximum of 15 mm in some embodiments. The maximum distance d and thus the maximum adjustment of the center axis A in the adjustment direction V can be a maximum of 12 mm in some embodiments. The maximum distance d and thus the maximum adjustment of the center axis A in the adjustment direction V can be a maximum of 10 mm in some embodiments. In some embodiments, the maximum distance d may be 12 mm. A. maximum distance d of 10 mm to 20 mm, for example 12 mm, can be provided in some embodiments in the production of plastic films. However, it can also be provided that the maximum distance d is larger or smaller. The maximum distance d can be selected depending on the intended manufacturing process, the intended use of the bearing adjustment device and/or the calender, and/or a web-like product or material to be manufactured. The maximum distance d can be selected, for example, by suitable choice of the dimensions and/or eccentricity of the outer eccentric sleeve 2, the inner eccentric sleeve 3 and/or the receptacle 4.

In some embodiments, the adjustment direction V may be a vertical direction. In some embodiments, the direction H may be a horizontal direction. Depending on the orientation of the bearing device and/or the design of the outer eccentric sleeve 2 and inner eccentric sleeve 3, other adjustment directions V are also possible.

If a bearing is accommodated in the receptacle 4, e.g. a rolling bearing, the axis of rotation of the bearing accommodated in the receptacle 4 can be or will be adjusted accordingly in the adjustment direction V. This means that a roller or roll supported by the bearing or bearing device 1 can also be adjusted accordingly.

In some other embodiments, the outer eccentric sleeve 2 and the inner eccentric sleeve 3 can be rotated by different angles and/or in the same direction of rotation in order to adjust the center axis A both in the adjustment direction V and in the direction H. In some embodiments, alternatively or additionally, the shape of the outer eccentric sleeve 2 and/or the inner eccentric sleeve 3 can be selected such that the center axis A can be adjustable both in the adjustment direction V and in the direction H. The angle of rotation, direction of rotation and/or shape of the outer eccentric sleeve 2 and/or the inner eccentric sleeve 3 can be suitably selected to enable a predetermined adjustment of the center axis A of the receptacle 4 in the adjustment direction V and direction H. If a bearing is accommodated in the receptacle 4, e.g. a rolling bearing, the axis of rotation of the bearing accommodated in the receptacle 4 can be or will be adjusted accordingly in the adjustment direction V and in the direction H. This allows a particularly flexible adjustment of the center axis A, and thus of a bearing accommodated in the receptacle 4 or of a roller or cylinder mounted by the bearing device 1.

The bearing adjustment device 1 can have a drive 10. The drive 10 can be configured to drive and/or rotate the inner eccentric sleeve 3 and/or the outer eccentric sleeve 2. The inner eccentric sleeve 3 may have a first eccentric gear 6. The first eccentric gear 6 can be arranged on an outer side of the inner eccentric sleeve 3 and/or enclose the inner eccentric sleeve 3. Alternatively, in some embodiments, the first eccentric gear 6 may also be an internal gear and/or be arranged on an inner side of the inner eccentric sleeve 3. The outer eccentric sleeve 2 may have a second eccentric gear 7. The second eccentric gear 7 can be arranged on an outer side of the outer eccentric sleeve 2 and/or enclose the outer eccentric sleeve 2. Alternatively, in some embodiments, it may be provided that the second eccentric gear 7 may also be an internal gear and/or may be arranged on an inner side of the outer eccentric sleeve 2. The first eccentric gear 6 can be arranged on one side of the bearing adjustment device 1, and the second eccentric gear 7 can be arranged on an opposite side of the bearing adjustment device 1, as shown, for example, in FIGS. 3 and 5.

The drive 10 may have a first gear 11. The first gear 11 can be coupled to the first eccentric gear 6, so that a rotation of the first gear 11 is or can be transmitted to the first eccentric gear 6, and/or vice versa. The drive 10 may have a third gear 13. The third gear 13 can be coupled to the second eccentric gear 7, so that a rotation of the third gear 13 is or can be transmitted to the second eccentric gear 7, and/or vice versa. It can be provided that the drive 10 has a second gear 12. The second gear 12 can be coupled to the first gear 11, so that a rotation of the second gear 12 can be or will be transmitted to the first gear 11, and thus indirectly to the first eccentric gear 6, and/or vice versa. The first gear 11 may be or comprise a first spur gear. The second gear 12 may be or comprise a second spur gear. The third gear 13 may be or comprise a third spur gear.

It can be provided that the first eccentric gear 6 is non-circular. If the outer eccentric sleeve 2 is eccentric, and/or the outer eccentric sleeve receptacle 25 is eccentric relative to the inner eccentric sleeve receptacle 26, the corresponding eccentricity can be or will be compensated by the non-circular first eccentric gear 6, so that the first gear 11 can be a round gear, e.g. a spur gear, for driving the first eccentric gear 6. It can be provided that the second eccentric gear 7 is non-circular. If the inner eccentric sleeve 3 is eccentric, and/or the inner eccentric sleeve receptacle 25 is eccentric relative to the receptacle 4, the corresponding eccentricity can be or will be compensated by the non-circular second eccentric gear 7, so that the third gear 13 can be a round gear, e.g. a spur gear, for driving the second eccentric gear 7.

At least one of the gears 6, 7, 11, 12, 13 may be a split gear and/or have at least two gear halves coupled to each other (not shown). It can be provided that one, several or all of the first eccentric gear 6, second eccentric gear 7, first gear 11, second gear 13 and/or third gear 13 can be a split gear and/or can have at least two gear halves coupled to one another. The gear halves can be coupled and/or clamped together, for example, via a spring, such as a torsion spring or an omega spring. Alternatively or additionally, the gear halves can be coupled and/or clamped together using an elastic material. The elastic material can be arranged between the gear halves. The elastic material can, for example, be or comprise an elastomer. If a gear is split, the division can result in improved contact and/or meshing of the teeth of the split gear with the teeth of another gear, or in better meshing. The gear play can be reduced or even brought to zero.

It can be provided that the drive 10 has a shaft 14. The shaft 14 may extend substantially parallel to the outer eccentric sleeve 2 and the inner eccentric sleeve 3, for example parallel to the axial direction C. The shaft 14 may couple the second gear 12 to the third gear 13. Thus, when the shaft 14 rotates, the outer eccentric sleeve 2 can rotate in the opposite direction to the inner eccentric sleeve 3. In some embodiments, it may be provided that the gear ratio of the first gear 11 to the first eccentric gear 6, of the second gear 12 to the first gear 11 and of the third gear 13 to the second eccentric gear 7 is selected such that when the shaft 14 rotates, the outer eccentric sleeve 2 and the inner eccentric sleeve 3 are or will be rotated in opposite directions relative to one another by the same angular amount. In some embodiments, it may be provided to select the respective gear ratio by a suitable number of teeth of the respective gears.

The drive 10 may be configured to drive and/or rotate the shaft 14 and/or apply a torque to the shaft 14.

The drive 10 may comprise a manual adjustment, an electric motor, a stepper motor, an encoder drive and/or a hydraulic motor.

The bearing adjustment device 1 may comprise a second drive (not shown) which may be configured to drive the inner eccentric sleeve 3 and/or the outer eccentric sleeve 2. The second drive may have one, several, or all of the features and/or advantages of the drive 10. The second drive may comprise a manual adjustment, an electric motor, a stepper motor, an encoder drive and/or a hydraulic motor.

By pre-tensioning both drives against each other, the position of the eccentric sleeves 2, 3 can be kept free of play. For example, one of the drives can block and the other can build up a defined preload with any torque to eliminate backlash. In some embodiments the second drive may be configured to drive and/or rotate the shaft 14 and/or apply a torque to the shaft 14. It can be provided that the drive 10 and the second drive can rotate the shaft 14 in the same and/or opposite direction of rotation, and/or can each apply torques on the shaft in the same or opposite direction, and/or with the same or different strength to the shaft 14.

The shaft 14 can be rotatably mounted by means of a gear rolling bearing 19 in the bearing adjustment device 1 and/or the housing 17 of the bearing adjustment device 1. Shaft 14, second gear 12 and/or third gear 13 can be axially secured by means of a gear retaining ring 20. The first gear 11 can be connected to a gear shaft 18. The gear shaft 18 can be rotatably mounted by means of a gear rolling bearing 19 in the bearing adjustment device 1 and/or the housing 17 of the bearing adjustment device 1. First gear 11 and/or gear shaft 18 can be axially secured with a gear retaining ring 20.

In some embodiments, the housing 17 of the bearing adjustment device 1 may have a first housing part 22 and a second housing part 23. The first housing part 22 may comprise a part of the outer eccentric sleeve receptacle 25 and/or the eccentric sleeve bearing 24. The second housing part 23 may comprise another part and/or remaining part of the outer eccentric sleeve receptacle 25 and/or the eccentric sleeve bearing 24. The first housing part 22 and the second housing part 23 can be connected to one another via connecting elements 21. Connecting element 21 may comprise a screw and/or a bolt. For example, the first housing part 22 and the second housing part 23 can be screwed together. If the housing 17 has a first housing part 22 and a second housing part 23, the bearing adjustment device 1 can be assembled or mounted and/or disassembled in a simple and uncomplicated manner.

As can be seen from FIG. 5, for example, the inner eccentric sleeve 3 can protrude beyond the outer eccentric sleeve 2. This means that the inner eccentric sleeve 2 can be or become axially secured in relation to the outer eccentric sleeve 3. In some embodiments, the first eccentric gear 6 and/or a web projecting from the inner eccentric sleeve 3 can secure the inner eccentric sleeve 3 relative to the outer eccentric sleeve 3 in a first axial direction. It can be provided that the inner eccentric sleeve 3 has a first retaining ring 15 which can axially secure the inner eccentric sleeve 3 relative to the outer eccentric sleeve 2. For example, the first retaining ring 15 can secure the inner eccentric sleeve 3 relative to the second eccentric sleeve 2 in a second axial direction. The first and second axial directions may be oriented opposite to each other. Thus, in some embodiments, the inner eccentric sleeve 3 can be axially secured relative to the outer eccentric sleeve 2 by the first retaining ring 15 and the first eccentric gear 6 and/or the protruding web.

As can be seen, for example, from FIG. 5, the outer eccentric sleeve 2 can project beyond the eccentric sleeve bearing 24, by means of which the outer eccentric sleeve can be rotatably mounted relative to the housing 17 and/or the bearing adjustment device 1. Thus, the outer eccentric sleeve 3 can be or become easily axially secured relative to the eccentric sleeve bearing 24, or the housing 17 and/or the bearing adjustment device 1. In some embodiments, the second eccentric gear 7 and/or a web projecting from the outer eccentric sleeve 2 can secure the outer eccentric sleeve 2 relative to the eccentric sleeve bearing 24 in a first axial direction. It can be provided that the outer eccentric sleeve 2 has a second retaining ring 16, which can axially secure the outer eccentric sleeve 2 relative to the eccentric sleeve bearing 24. For example, the second retaining ring 16 can secure the outer eccentric sleeve 2 relative to the eccentric sleeve bearing 24 in a second axial direction. The first and second axial directions may be oriented opposite to each other. Thus, in some embodiments, the outer eccentric sleeve 2 can be axially secured relative to the eccentric sleeve bearing 24, or the housing 17 and/or the bearing adjustment device 1, by the second retaining ring 16 and the second eccentric gear 7 and/or the protruding web.

An exemplary embodiment of a calender 100 according to the invention is shown in FIG. 6. The calender 100 has at least one bearing adjustment device 1 according to the invention (not shown in FIG. 6). The bearing adjustment device 1 may have one, several or all features of the bearing adjustment devices 1 described above and shown in FIGS. 1 to 5.

The calender 100 has a roller pair formed from two rollers 102. A roller nip 104 is formed between the rollers 102. The calender 100 may be configured to produce a web-like material and/or to be used in at least one step of the production process. For example, the calender 100 can be used in the production of films, e.g. plastic films. In some embodiments, a material, such as a plastic material, may be introduced into the nip 104 and formed into a film, such as a plastic film, by the rollers 102. The bearing adjustment device 1 can be used to vary the roller nip 104 in order to adjust, for example, the film thickness and film quality. In some other embodiments, the calender 100 may be configured or used to coat a web-like carrier. The web-like carrier may be or be guided through the nip, and one or both of the rollers 102 may be configured to apply a coating material to the web-like carrier. The bearing adjustment device 1 can serve to vary the roller nip 104 in order to adjust, for example, the thickness of the coating and/or the coated web-like carrier, and/or their quality. In some other embodiments, the calender 100 may be configured to be used in powder milling and/or to produce a polymer-metal dry film. In some other embodiments, the calender 100 may be configured to produce an electrode, in particular a dry electrode, and/or an electrode precursor, or may be used in the production thereof.

The bearing adjustment device 1 can support a lateral end of a roller 102. If the center axis A of the receptacle 4 of the bearing adjustment device 1 is adjusted in the adjustment direction V (and/or in some embodiments alternatively or additionally in the direction H), the axis of rotation of the roller 102 can be adjusted accordingly. In some embodiments, both ends of the roller 102 may be supported by a respective bearing device 1. In some embodiments, both rollers 102 of the roller pair, and/or both lateral ends of both rollers 102 of the roller pair, can be supported by a respective bearing device 1. By adjusting one, several or all central axes A of one or more bearing adjustment devices 1, one or both of the rollers 102 can be pivoted or axially crossed relative to the other roller 102 of the roller pair. It can be provided that none, several or all of the bearing adjustment devices 1 are or will be adjusted equally. This allows the axis crossing of the rollers 102 and/or the thickness of the roller nip 104 to be adjusted flexibly and easily, even during operation.

The calender may have a powder hopper 101. A powdered electrode film precursor material may be or will be filled into the powder hopper 101. The powder hopper 101 may be configured to deliver the electrode film precursor material into the roller nip 104. The electrode film precursor material delivered into the roller nip 104 may be compressed by the rollers 102.

In some embodiments, the calender 100 may include a support roller 103. The support roller 103 can be arranged such that it can laterally support a roller 102 of the roller pair in order to support the roller 102, for example, against lateral transverse forces. In some embodiments, the support roller 103 may contact the roller 102. It can be provided that the calender 100 can have two support rollers 103, wherein each of the rollers 102 of the roller pair can be laterally supported by one of the support rollers 103.

In some embodiments, one or both of the support rollers may be supported at one or both lateral ends by a respective further bearing adjustment device 1. Thus, the support roller 103 can be adjusted accordingly when adjusting the roller 102 (e.g. in adjustment direction V and/or direction H) in order to ensure lateral support even when the roller 102 is adjusted.

The bearing adjustment device 1 can also be used to adjust engraving rollers or embossing rollers. Engraving devices or embossing devices may have one or more bearing devices 1. An engraving device can, for example, have at least one engraving roller, which can be mounted with a bearing device 1. An embossing device can, for example, have at least one embossing roller, which can be mounted with a bearing device 1. For example, by adjusting the height and/or position of the engraving roller and/or embossing roller, the bearing device 1 can adjust an engraving and/or embossing force exerted by the engraving roller and/or embossing roller on an object to be engraved or embossed. Depending on the material of the object to be embossed or engraved, and/or the type, shape, or e.g. depth of the engraving or embossing, the bearing adjustment device 1 can adjust the engraving roller and/or embossing roller appropriately or accordingly, and/or the engraving roller and/or embossing roller can be or will be adjusted by the bearing adjustment device 1.

The invention further relates to a method for producing an electrode film, not shown in the figures. Powdered electrode film precursor material can be compressed by a calender 100 as described above. As described above, at least one of the rollers can be pivoted and/or axially crossed relative to the other roller in order to ensure a good and uniform quality of the compressed electrode film precursor material.

After compression, the compressed electrode film precursor material can be film-shaped. In some embodiments, the electrode film precursor material may be compressed to a thickness that is greater than the thickness of the electrode film precursor material to be subsequently laminated to a metal foil. It may be provided that the compressed electrode film precursor material is further compressed after compression. For this purpose, for example, an additional roller pair can be provided. The further roller pair may have a suitable roller nip width, which may, for example, be smaller than the nip width of the roller nip 104 of the rollers 102 for compressing the powdered electrode film precursor material. It can be provided that one or both rollers of the roller pair are mounted with one or more bearing adjustment devices 1 described above for further pressing the compressed electrode film precursor material.

After further pressing, the further pressed electrode film precursor material may be film-shaped. The thickness of the further pressed electrode film precursor material may be smaller than the thickness of the compressed electrode film precursor material. The thickness of the further pressed electrode film precursor material may correspond to the thickness of the electrode film precursor material to be subsequently laminated onto a metal foil.

The further pressed electrode film precursor material can then be laminated onto a metal foil to form an electrode film. The lamination can be carried out with a further roller pair, wherein in some embodiments the further roller pair can be mounted with at least one bearing adjustment device 1. In some embodiments, it may be provided to laminate a further pressed electrode film precursor material onto both sides of the metal foil, so that a double-sided laminated electrode film can be formed.

In some embodiments, the compressed electrode film precursor material may already have a thickness at which it can be laminated to the metal foil to form the electrode film. In these cases, it may be provided that further pressing can be omitted, so that the compressed electrode film precursor material can be laminated onto the metal foil during lamination. In some embodiments. it may be provided to laminate a further pressed electrode film precursor material onto both sides of the metal foil, so that a double-sided laminated electrode film can be formed.

The formed electrode film can then be used, for example, to produce a dry electrode.

The features of the invention disclosed in the above description, in the figures, and in the claims can be essential for the implementation of the invention both individually and in any combination.

### LIST OF REFERENCE NUMERALS

1 bearing adjustment device
2 outer eccentric sleeve
3 inner eccentric sleeve
4 receptacle
5 center point
6 first eccentric gear
7 second eccentric gear
8 first side
9 second side
10 drive
11 first gear
12 second gear
13 third gear
14 shaft
15 first retaining ring
16 second retaining ring
17 housing
18 gear shaft
19 gear rolling bearing
20 gear retaining ring
21 connecting element
22 first housing part
23 second housing part
24 eccentric sleeve bearing
25 outer eccentric sleeve receptacle
26 inner eccentric sleeve receptacle
100 calender
101 powder hopper
102 roller
103 support roller
104 roller nip
d distance
V adjustment direction
H direction perpendicular to the displacement direction
A center axis
B adjusted center axis
C axial direction

1. A bearing adjustment device which has a rotatably mounted outer eccentric sleeve and a rotatable inner eccentric sleeve which is received in the outer eccentric sleeve, wherein the inner eccentric sleeve has a receptacle wherein the outer eccentric sleeve and the inner eccentric sleeve can be rotated relative to one another, preferably in opposite directions, and are configured such that in the event of a relative rotation, preferably an opposite rotation, of the outer eccentric sleeve with respect to the inner eccentric sleeve, a center axis (A) of the receptacle is adjusted in an adjustment direction (V), preferably in a vertical direction.

2. The bearing adjustment device according to claim 1, wherein the center axis (A) of the receptacle is adjustable by a maximum distance (d) in the adjustment direction (V) of up to 20 mm, preferably up to 15 mm, particularly preferably 12 mm.

3. The bearing adjustment device according to claim 1, in which the outer eccentric sleeve and the inner eccentric sleeve are configured such that when the outer eccentric sleeve is rotated in the opposite direction relative to the inner eccentric sleeve, the center axis (A) of the receptacle is not adjusted in a direction (H) perpendicular to the adjustment direction (V), preferably not in a horizontal direction.

4. The bearing adjustment device according to claim 1, in which the inner eccentric sleeve has a first eccentric gear, wherein preferably the first eccentric gear is or has a non-circular gear.

5. The bearing adjustment device according to claim 1, in which the outer eccentric sleeve has a second eccentric gear, wherein preferably the second eccentric gear is or has a non-circular gear.

6. The bearing adjustment device according to claim 5, wherein the first eccentric gear is arranged on a first side of the bearing adjustment device, and the second eccentric gear is arranged on a second side of the bearing adjustment device, wherein the second side is arranged opposite the first side.

7. The bearing adjustment device according to claim 1, wherein the bearing adjustment device has a drive which is designed to drive and/or rotate the inner eccentric sleeve and/or the outer eccentric sleeve.

8. The bearing adjustment device according to claim 7, wherein the drive has a first gear coupled to the first eccentric gear, a second gear coupled to the first gear, and a third gear coupled to the second eccentric gear, wherein preferably the first gear is a first spur gear, preferably the second gear is a second spur gear, and preferably the third gear is a third spur gear.

9. The bearing adjustment device according to claim 8, wherein the drive has a shaft which couples the second gear to the third gear, wherein preferably the shaft extends substantially parallel to the inner eccentric sleeve and the outer eccentric sleeve.

10. The bearing adjustment device according to claim 9, wherein the transmission ratio of the first gear to the first eccentric gear, of the second gear to the first gear and of the third gear to the second eccentric gear are selected such that upon rotation of the shaft, the inner eccentric sleeve is rotated relative to the second eccentric sleeve by the same angle in terms of its value in the opposite direction.

11. The bearing adjustment device according to claim 4, in which at least one of the first eccentric gear, the second eccentric gear, the first gear, the second gear and/or the third gear is a split gear and/or has at least two gear halves coupled to one another.

12. The bearing adjustment device according to claim 7, which has a second drive which is designed to drive the inner eccentric sleeve and/or the outer eccentric sleeve.

13. The bearing adjustment device according to claim 1, in which the outer eccentric sleeve, the inner eccentric sleeve and the receptacle are aligned parallel to one another.

14. The bearing adjustment device according to claim 1, in which the first eccentric gear is arranged such that it axially secures the inner eccentric sleeve relative to the outer eccentric sleeve, wherein the inner eccentric sleeve preferably has a first retaining ring which axially secures the inner eccentric sleeve relative to the outer eccentric sleeve, wherein the first retaining ring is preferably arranged opposite the first eccentric gear.

15. The bearing adjustment device according to claim 1, in which the outer eccentric sleeve is rotatably mounted in a housing, wherein the second eccentric gear axially secures the outer eccentric sleeve relative to the housing, wherein preferably the outer eccentric sleeve has a second retaining ring which axially secures the outer eccentric sleeve relative to the housing, wherein preferably the second retaining ring is arranged opposite the second eccentric gear.

16. The bearing adjustment device according to claim 1, wherein the bearing adjustment device has a bearing which is arranged in the receptacle, wherein the bearing is or has preferably a rolling bearing.

17. A calender comprising a bearing adjustment device according to claim 1 and a roller pair with a roller nip between the rollers of the roller pair, one of the rollers being supported by the bearing adjustment device.

18. The calender according to claim 17, wherein each of the rollers of the roller pair is mounted at its lateral ends by a respective bearing adjustment device according to claim 1.

19. The calender according to claim 17, which has a powder hopper for filling powder into the roller nip.

20. The calender according to claim 17, which has a support roller, wherein the support roller laterally supports one of the rollers of the roller pair.

21. The calender according to claim 20, wherein the support roller is mounted by a further bearing adjustment device.

22. The calender according to claim 17, in which one of the rollers of the roller pair is pivoted and/or axially crossed relative to the other roller of the roller pair by adjusting the center axis (A) of the receptacle of the bearing adjustment device in the adjustment direction (V).

23. A method for producing a web-like product using a calender the method comprising the steps of:
feeding a precursor material into a roller nip of a roller pair of the calender;
producing the web-like product, wherein at least one of the rollers of the roller pair contacts the precursor material in the roller nip;
wherein during the production of the web-like product, at least one of the rollers of the roller pair is pivoted and/or axially crossed relative to the other roller, wherein the adjustment and/or axial crossing of the roller comprises an adjustment of a center axis (A) of a bearing adjustment device according to claim 1, which supports the roller, in an adjustment device (V).

24. The method according to claim 23, wherein the precursor material comprises a plastic and the web-like product is a plastic film, wherein during the manufacture of the web-like product the precursor material is formed into the plastic film by the rollers.

25. The method according to claim 23, wherein the precursor material comprises a web-like carrier and one of the rollers is or comprises a coating roller, wherein in the production of the web-like product a coating agent is applied to the web-like carrier by the coating roller.

26. The method according to claim 23, wherein the precursor material comprises a powdered electrode film precursor material, wherein the supplying of the precursor material in the method comprises the steps of:
filling a powdered electrode film precursor material into a powder hopper of the calender;
introducing the powdered electrode film precursor material with the powder hopper into a roller nip of a roller pair of the calender;
and wherein the production of the web-like product comprises compressing the powdered electrode film precursor material with the rollers of the roller pair of the calender.

27. The method according to claim 26, wherein after compressing the electrode film precursor material, the compressed electrode film precursor material is further pressed, preferably with a further roller pair.

28. The method according to claim 26, wherein the compressed electrode film precursor material and/or the further pressed electrode film precursor material is compressed and/or pressed into a film.

29. The method according to claim 26, wherein an electrode film is formed, wherein the forming of the electrode film comprises laminating the compressed electrode film precursor material and/or the further pressed electrode film precursor material onto a metal foil.

30. The method according to claim 29, wherein in forming the electrode film, a first compressed electrode film precursor material and/or a first further compressed electrode film precursor material is laminated onto a first side of the metal foil, and a second compressed electrode film precursor material and/or a second further compressed electrode film precursor material is laminated onto a second side of the metal foil opposite the first side.
